(19) United States
(12) Patent Application Publication
(10) Pub. No.: US 2007/0123357 A1
(43) Pub. Date: May 31, 2007

(54) Direct torque flow constant velocity joint with male connector

(76) Inventors: Steven C. Hahn, Shelby Township, MI (US); Hans Wormsbächer, Lake Orion, MI (US)

Correspondence Address: GKN DRIVELINE NORTH AMERICA, INC, 3300 UNIVERSITY DRIVE, AUBURN HILLS, MI, 48326, US

(21) Appl. No.: 11/288,466

(22) Filed: Nov. 29, 2005

(51) Int. Cl. F16D 3/34

(52) U.S. Cl. 464/145

(57) ABSTRACT

A direct torque flow constant velocity joint direct connector is provided. The direct torque flow constant velocity joint direct connector includes an inner joint part, shaft, a plurality of balls and an outer joint part. The outer joint part is connected to the shaft and articulately secured in a rotationally fast way to the inner joint part by the plurality of balls. The inner joint part includes an extension for direct engagement with a drive unit. Also, a direct torque flow constant velocity joint connection is provided that includes a drive unit coupled to a direct torque flow constant velocity joint male spline connector.

### TECHNICAL FIELD

The present invention relates generally to motor vehicle shaft joints, and more particularly concerns a direct torque flow constant velocity joint having a male connection end.

### BACKGROUND

Constant velocity joints (CVJ) connecting shafts to drive units are common components in automotive vehicles. The drive unit typically has an output shaft or an input shaft for receiving the joint. Typically, the drive unit is an axle, transfer case, transmission, power take-off unit or other torque device, all of which are common components in automotive vehicles. Typically, one or more joints are assembled to the shaft to form a propeller or drive shaft assembly. It is the propeller shaft assembly which is connected, for instance, at one end to the output shaft of a transmission and, at the other end, to the input shaft of a differential. The propeller shaft is solid or tubular with ends adapted to attach the shaft to an inner race of the joint thereby allowing an outer race connection with a drive unit. The inner race of the joint is typically press-fit, splined, or pinned to the shaft thereby making the outer race of the joint available to be bolted or press-fit to a hub connector, flange or stubshaft of the particular drive unit. At the other end of the propeller shaft, the same typical connection is made to a second drive unit when connecting the shaft between the two drive units. Connecting the shaft to a drive unit via the constant velocity joint in this manner is considered to be a traditional connection. Direct torque flow (DTF) connection is a newer connection style that has advantages and improvements over the traditional connection.

A DTF connection is different from the traditional connection because the outer race of the DTF connection is connected to the shaft that extends between different joints and the inner race is connectable to a drive unit. One example of a DTF connection provides the outer race of a CVJ friction welded to a propeller shaft, and the inner race of the CVJ includes a female spline that is connectable to a journal shaft of a transmission. However, a disadvantage of such an arrangement is that the inner race of the CVJ has a female connector type that necessitates connection to a shaft having a male connector extending from a drive unit. In addition, a seal is required somewhere between the shaft and inner race if the CVJ lubrication is to be maintained and the joint environment controlled. Moreover, the DTF connector is an indirect connection.

It would be advantageous to have a DTF constant velocity joint that overcomes the limitations indicated above. Moreover, it would be advantageous to have a DTF constant velocity joint that provides for direct connection to a drive unit. Furthermore, it would be advantageous to provide a DTF constant velocity joint having an improved seal.

### SUMMARY OF THE INVENTION

Accordingly, the present invention provides a direct torque flow constant velocity joint (DTF CVJ) having a male connection end. The DTF CVJ male connector has a male extension shaft axially extending from the inner race that may provide for direct connection to a drive unit such as a transmission, transfer case or axle. The DTF CVJ male connector allows for additional flexibility in mounting positions of a sealing system and provides a reduction in the number of seals required for a constant velocity joint.

In one embodiment, a DTF CVJ direct connector includes an inner joint part, a shaft, a plurality of balls, and an outer joint part. The outer joint part is connected to the shaft and is articulately secured in a rotationally fast way to the inner joint part by the plurality of balls. The inner joint part includes an extension for direct engagement with a drive unit.

Also, a direct torque flow constant velocity joint connection is provided that includes a drive unit coupled to a direct torque flow constant velocity joint male spline connector.

The present invention provides a DTF CVJ male connector. The present invention itself will be best understood by reference to the following detailed description and taken in conjunction with the accompanying drawings.

### BRIEF DESCRIPTION OF THE DRAWINGS

For a more complete understanding of this invention, reference should now be made to the embodiments illustrated in greater detail in the accompanying drawings and described below by way of examples of the invention.

FIG. 1 shows a plan view of an exemplary drive system for a typical four-wheel drive automobile wherein the present invention may be used.

FIG. 2 shows an embodiment of an inventive direct torque flow constant velocity joint male connector.

### DETAILED DESCRIPTION

In the following description, various operating parameters and components are described for one or more constructed embodiments. These specific parameters and components are included as examples and are not meant to be limiting.

While the invention is described with respect to a direct torque flow constant velocity universal joint for use in a vehicle, the following apparatus is capable of being adapted for various purposes including automotive vehicle drive axles, motor systems that use a propeller shaft, or other vehicle and non-vehicle applications which require propeller shaft assemblies for torque transmission.

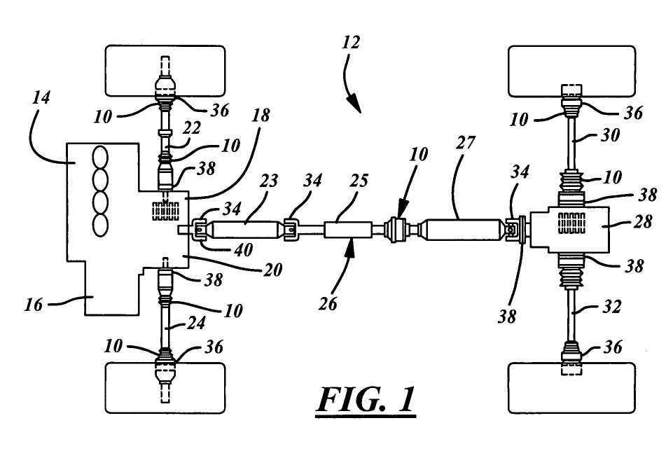

An exemplary drive system 12 for a typical four-wheel drive automobile is shown in FIG. 1. While a four-wheel drive system is shown and described, the concepts here presented could apply to a single drive unit system or multiple drive unit system, including rear wheel drive only vehicles, front wheel drive only vehicles, all wheel drive vehicles, and four-wheel drive vehicles. In this example, the drive system 12 includes an engine 14 that is connected to a transmission 16 and a power take-off unit 18. A front differential 20 has a right hand side half shaft 22 and left hand side half shaft 24, each of which are connected to a wheel and deliver power to the wheels. On both ends of the right hand side half shaft 22 and left hand side half shaft 24 are constant velocity joints 10. A propeller shaft 26 connects the front differential 20 to a rear differential 28 wherein the rear differential 28 includes a rear right hand side shaft 30 and a rear left hand side shaft 32, each of which ends with a wheel on one end thereof. Constant velocity joints 10 are located on both ends of the half shafts 30, 32 that connect to the wheels and the rear differential 28. The propeller shaft 26, shown in FIG. 1, is a three-piece propeller shaft that includes a plurality of Cardan joints 34 and one high-speed constant velocity joint 10. The propeller shaft 26 includes interconnecting shafts 23, 25, 27. The constant velocity joints 10 transmit power to the wheels through the propeller shaft 26 even if the wheels or the propeller shaft 26 have changed angles due to steering, or raising or lowering of the suspension of the vehicle. The constant velocity joints 10 may be any of the standards types known, such as a plunging tripod, the cross groove joint, a fixed ball joint, a fixed tripod joint, or double offset joint, all of which are commonly known terms in the art for different varieties of constant velocity joints 10. The constant velocity joints 10 allow for transmission of constant velocities at angles typically encountered in every day driving of automotive vehicles in both the half shafts, interconnecting shafts and propeller shafts of these vehicles. Optionally, each Cardan joint 34 may be replaced with any other suitable type of joint, including constant velocity joint types. The inventive direct torque flow constant velocity joint (DTF CVJ) having a male connection end may be utilized to advantage for any of the above mentioned joint locations requiring a plunging or fixed type of constant velocity joint.

The shafts 22, 23, 24, 25, 27, 30, 32 may be solid or tubular with ends adapted to attach each shaft to an inner race or the outer race of a joint, in accordance with a traditional connection or a direct torque flow connection, thereby allowing the outer race or inner race to be connected to a hub connector 36, a flange 38 or stubshaft 40 of each drive unit, as appropriate, for the particular application. At least one of the connections identified in FIG. 1 at 10 or 34 may be direct torque flow connection in accordance with an embodiment of the present invention.

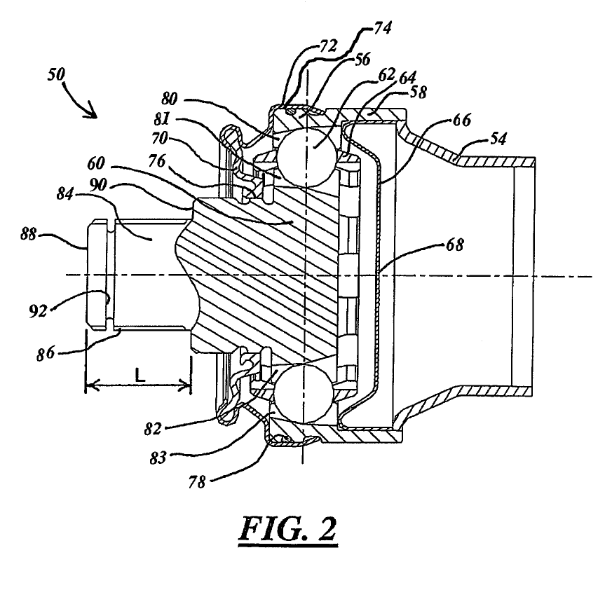

For completeness of the description of the embodiment of the present invention as given in FIG. 2, the term direct torque flow (DTF) connection refers to a connection from the inner race of a constant velocity joint (CVJ) to the shaft of a differential, transmission or transfer case, generally supplied by the customer. This kind of connection would be a DTF indirect connection because the inner race of a CVJ has a female coupling usable to advantage for connecting up to the supplied drive unit. However, as will be described below, the DTF connection may be a DTF direct connection. The DTF direct connection includes a shaft section axially extending from the inner race of a CVJ that is usable to advantage for connecting to a supplied drive unit. The DTF indirect connection typically is in the form of a spline because of its robust design features as understood by one skilled in the art. However, it is anticipated that other forms of connection are appropriate including fixed and releaseable connections between the inner race and shaft for the DTF indirect connection. Thus, a DTF connection, whether direct or indirect, refers to the inner race coupling with a drive unit, such as a differential, transmission or transfer case, without limitation, as opposed to the traditional connection mentioned above.

Also, as used herein, a DTF connector refers to an outer race of a CVJ coupled to a shaft which forms a DTF assembly, such as a DTF propshaft assembly. Only together with the supplied drive unit, such as a differential, coupled to a inner race, for example, does a DTF connector combine to make a DTF connection. It is recognized that the drive unit may include any input or output drive unit and is not necessarily limited to a differential, a transmission or a transfer case.

FIG. 2 shows an embodiment of an inventive direct torque flow constant velocity joint male connector 50. The DTF CVJ male connector 50 is connected to a propeller shaft 54 of a motor vehicle driveline. The DTF CVJ male connector 50 comprises an outer joint part 56 welded to the propeller shaft 54 by a collar 58, an inner joint part 60, torque transmitting balls 62 as well as a ball cage 64. Between the collar 58 and the outer joint part 56 there is inserted a cover 66, which seals the joint toward the propeller shaft 54 and, more particularly, contains lubrication within the joint. The cover 66 may include a vent port 68 for balancing pressure developed within the joint. Furthermore, a membrane seal 70 circumferentially connected to a shield 72, which is connected to an outer surface 74 of the outer joint part 56, is in sealing relationship with the inner surface 76 of the inner joint part 60 and completes the DTF CVJ male connector 50 seal. A backup seal 78 may be included between the shield 72 and the outer joint part 56. The membrane seal 70 is connected to the inner surface 76 of the inner joint part 60 in such a way as to allow for articulation between the inner joint part 60 and the outer joint part 56 while maintaining seal integrity. The boot or membrane seal 70 for sealing of a constant velocity joint is well understood by a person having skill in the art. Articulation of the DTF CVJ male connector 50 is accomplished by the balls 62 transitioning within pairs of ball tracks 80, 81, 82, 83. The orientation of each ball track set is dependent upon the type of universal joint selected, which is well understood to a person having skill in the art. However, the ball tracks 80, 81, 82, 83 of the present invention are of the non-plunging type for CVJ applications requiring angular offset between the shaft 54 and a drive unit (not shown) that are connected via the joint. The inner joint part 60 further includes an axial extension 84 axially extending outwardly a length L from the connector 50. The axial extension 84 includes a spline 86 in which the connector 50 may be axially secured to a drive unit (not shown) in a rotationally fast way. The spline 86 may be of any type or form and is well understood to a person of skill in the art. The axial extension 84 allows for direct or male coupling with a particular drive unit without the need for a seal that would be typically required between a journal shaft and an inner joint part of a DTF constant velocity joint indirect connection.

The inner joint part 60 further includes a front face 88, a seat 90 and a groove 92. A clip (not shown) may be utilized in the groove 92 to axially secure the connector 50 to a drive unit (not shown) with a circlip (not shown) when the front face 88 of the inner joint part 60 is inserted into a connection port (not shown) of the drive unit, thereby bringing the seat 90 of the connector 50 into proximity with the drive unit.

Although the present invention as described in the embodiment illustrated in FIG. 2 utilizes a DTF CVJ male connector 50 having a spline 86 on the extension 84 of the inner joint part 60, it is intended that the inventive DTF CVJ having a male connector may be applied equally to constant velocity joints having other male connection types.

A seat 90, a front face 88 or an extension 84 of an inner joint part may include, optionally, a drive unit seal (not shown) allowing for sealing connection between a drive unit and a connector 50. Moreover, more than one drive unit seal (not shown) may be utilized to seal or protect a spline 86 or an extension 84 of the inner joint part 60 from contamination when coupled to a drive unit.

Optionally, a power take-off (PTO) adaptor (not shown) may be included in an extension 84. The adaptor may include a female spline (not shown) extending internally into the extension 84 being accessible from the front face 88 of the extension. The adaptor may also axially extend through the extension to the inner joint part 60. By providing the power take-off adaptor, a second shaft (not shown) may be received and axially secured to a DTF CVJ male connector 50 in a rotationally fast way. Advantageously, the DTF CVJ male connector 50 together with the optional PTO adaptor enables shaft-to-shaft coupling for shaft extension and PTO applications.

Another option is a threaded port (not shown) that extends internally from a front face 88 into an extension 84 that axially extends from an inner joint part 60, whereby a bolt (not shown) may be received and axially secured to a DTF CVJ male connector 50 in a fast way. Advantageously, the DTF CVJ male connector 50 together with optional threaded port enable the inner joint part 60 to be secured to a drive unit (not shown) by the bolt. A person of skill in the art will recognized that the circlip (not shown) may be eliminated on the inventive DTF CVJ male connector 50 when the threaded port option is selected.

While the material, manufacture and treatment of the DTF CVJ male connector 50 has not been discussed, appropriate selection would be well understood by a person of skill in the art.

While the above embodiment of a DTF CVJ male connector having a spline on an extension of an inner joint part is provided as an example, it is recognized that various other types of direct or male connector configurations may also be used with the inventive DTF CVJ male connector, for example, without limitation, a keyed tooth.

Accordingly, the present invention provides a direct torque flow constant velocity joint (DTF CVJ) having a male connection end. The DTF CVJ has a male extension shaft axially extending from an inner race that may provide for direct connection to a drive unit such as a transmission, a transfer case or an axle. The DTF CVJ male connector allows for additional flexibility in mounting positions of a constant velocity joint and provides a reduction in the number of seals required for a constant velocity joint.

From the foregoing, it can be seen that there has been brought to the art a new and improved DTF CVJ male connector. While the invention has been described in connection with one or more embodiments, it should be understood that the invention is not limited to those embodiments. On the contrary, the invention covers all alternatives, modifications, and equivalents as may be included within the spirit and scope of the appended claims.

What is claimed is:

1. A direct torque flow constant velocity joint direct connector comprising:
an inner joint part;
a shaft;
a plurality of balls; and
an outer joint part coupled to said shaft and articulately secured in rotationally fast way to said inner joint part with said plurality of balls,
wherein said inner joint part includes an extension for direct engagement with a drive unit.

2. A direct torque flow constant velocity joint direct connector according to claim 1 wherein said extension includes a spline.

3. A direct torque flow constant velocity joint direct connector according to claim 1 wherein said extension includes a keyed tooth.

4. A direct torque flow constant velocity joint direct connector according to claim 1 wherein said extension includes a groove for axial retention with a drive unit.

5. A direct torque flow constant velocity joint direct connector according to claim 4 further comprising a circlip coupled to said groove of said inner joint part.

6. A direct torque flow constant velocity joint direct connector according to claim 1 wherein said inner joint part includes a seat, whereby a seal of a drive unit may be sealingly coupled to said seat.

7. A direct torque flow constant velocity joint direct connector according to claim 1 wherein said extension of said inner joint part has a front face and further includes a female spline extending internally into said extension from said front face, whereby said female spline enables shaft-to-shaft extensions.

8. A direct torque flow constant velocity joint direct connector according to claim 1 wherein said extension of said inner joint part has a front face and further includes a threaded port extending internally into said extension from said front face, whereby said threaded port is adapted to receive a bolt for securing a drive unit.

9. A direct torque flow constant velocity joint direct connector according to claim 1 further including a cover sealingly positioned between said shaft and said outer joint; a boot sealingly positioned between said inner joint part and said outer joint part; and a ball cage supporting said plurality of balls, wherein lubrication is maintained within the joint.

10. A direct torque flow constant velocity joint male connector comprising:
an inner joint part;
a shaft;
a plurality of balls;
a ball cage supporting said plurality of balls;
an outer joint part coupled to said shaft and articulately secured in rotationally fast way to said inner joint part with said plurality of balls;
a cover sealingly positioned between said shaft and said outer joint; and
a boot sealingly positioned between said inner joint part and said outer joint part, wherein said inner joint part includes an extension for direct engagement with a drive unit; and
lubricant is sealed within the a cavity defined by said inner joint part, said outer joint part, said cover and said boot without engagement with a drive unit.

11. A direct torque flow constant velocity joint male connector according to claim 10 wherein said extension includes a spline.

12. A direct torque flow constant velocity joint male connector according to claim 10 wherein said extension includes a groove for axial retention with a drive unit.

13. A direct torque flow constant velocity joint male connector according to claim 12 further comprising a circlip coupled to said groove of said inner joint part.

14. A direct torque flow constant velocity joint male connector according to claim 10 wherein said inner joint part includes a seat, whereby a seal of a drive unit may be sealingly coupled to said seat.

15. A direct torque flow constant velocity joint male connector according to claim 10 wherein said extension of said inner joint part has a front face and further includes a female spline extending internally into said extension from said front face, whereby said female spline enables shaft-to-shaft extensions.

16. A direct torque flow constant velocity joint male connector according to claim 10 wherein said extension of said inner joint part has a front face and further includes a threaded port extending internally into said extension from said front face, whereby said threaded port is adapted to receive a bolt for securing a drive unit.

17. A direct torque flow constant velocity joint male spline connection comprising:
a drive unit having a female spline; and
a DTF CVJ male spline connector coupled to said female spline of said drive unit, said DTF CVJ male spline connector comprising:
an inner joint part;
a shaft;
a plurality of balls;
a ball cage supporting said plurality of balls;
an outer joint part coupled to said shaft and articulately secured in rotationally fast way to said inner joint part by said plurality of balls;
a first cover sealingly positioned between said shaft and said outer joint; and
a second membrane sealingly positioned between said inner joint part and said outer joint part, wherein said inner joint part includes an extension directly coupled to said drive unit, and lubricant is sealed within the connector independently from said drive unit.

18. A direct torque flow constant velocity joint male spline connection according to claim 17 further comprising a circlip coupled to a groove in said inner joint part axially retaining said drive unit.

19. A direct torque flow constant velocity joint male spline connection according to claim 17 wherein said inner joint part includes a seat and a front face, wherein a first seal of said drive unit is sealingly coupled to said seat and a second seal of said drive unit is sealingly coupled to said front face, thereby sealing said extension.

20. A direct torque flow constant velocity joint male spline connection according to claim 17 further includes a bolt, wherein said extension of said inner joint part has a front face and further includes a threaded port extending internally into said extension from said front face, wherein said drive unit is releasably coupled to said DTF CVJ male spline connector by said bolt.
